(19) United States
(12) Patent Application Publication
(10) Pub. No.: US 2018/0105276 A1
(43) Pub. Date: Apr. 19, 2018

(54) AIRCRAFT DEICING SYSTEM

(71) Applicant: Richard S. Wilkins, Provo, UT (US)

(72) Inventor: Richard S. Wilkins, Provo, UT (US)

(21) Appl. No.: 15/783,846

(22) Filed: Oct. 13, 2017

Related U.S. Application Data
(60) Provisional application No. 62/408,524, filed on Oct. 14, 2016.

(51) Int. Cl. B64D 15/16; B64D 15/22

(52) U.S. Cl. CPC B64D 15/16; B64D 15/04; B64D 15/22

(57) ABSTRACT

For deicing an aircraft, a deicing system includes a base, a plurality of motorized wheel assemblies, a proximal deck and a distal deck, and a plurality of articulated arms. The base may have a length along the longitudinal axis that is substantially equivalent to a specified aircraft. The plurality of motorized wheel assemblies is disposed under the base. A movement direction of each wheel assembly is rotatable about a vertical axis. The plurality of articulated arms is disposed on the proximal deck in the distal deck. A shell is disposed on the end of each articulated arm. The plurality of motorized wheel assemblies moves the deicing system adjacent to the aircraft and the plurality of articulated arms each position a shell adjacent to the aircraft.

### CROSS-REFERENCE TO RELATED APPLICATIONS

This application claims priority to U.S. Provisional Patent Application Ser. No. 62/408,524 entitled “AIRCRAFT DEICING SYSTEM” and filed on Oct. 14, 2107 for Richard S. Wilkins, which is incorporated herein by reference.

### FIELD

The subject matter disclosed herein relates to deicing and more particularly relates to an aircraft deicing system.

### BACKGROUND

### Description of the Related Art

Aircraft must currently be deiced in an area removed from a runway.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a side view drawing illustrating one embodiment of a deicing system;

FIG. 1B is a schematic side view drawing illustrating one embodiment of a deicing system;

FIG. 1C is a schematic front view drawing illustrating one embodiment of a deicing system;

FIG. 2 is a perspective drawing illustrating one embodiment of a fuselage shell;

FIG. 3 is a side view drawing illustrating one embodiment of a wing and tail shell;

FIG. 4A is a perspective drawing illustrating one embodiment of a deicing system adjacent to an aircraft;

FIG. 4B is a perspective drawing illustrating one embodiment of a deicing system adjacent to an aircraft;

FIG. 4C is a perspective drawing illustrating one alternate embodiment of a deicing system adjacent to an aircraft;

FIG. 5 is a schematic block diagram illustrating one embodiment of a computer; and

FIGS. 6A-B are schematic flow chart diagrams illustrating one embodiment of an aircraft deicing method.

### DETAILED DESCRIPTION

The description of elements in each figure may refer to elements of proceeding figures. Like numbers refer to like elements in all figures, including alternate embodiments of like elements.

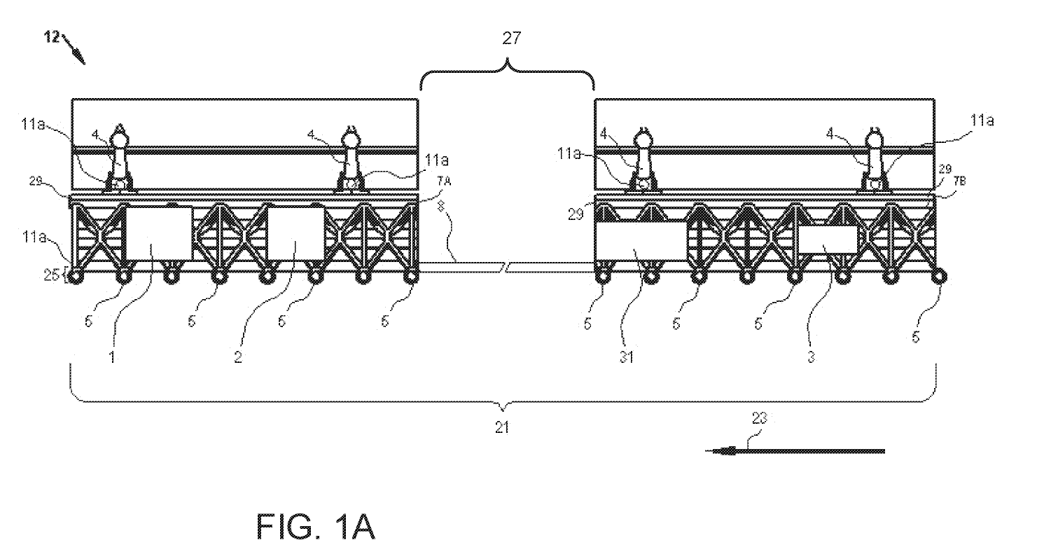

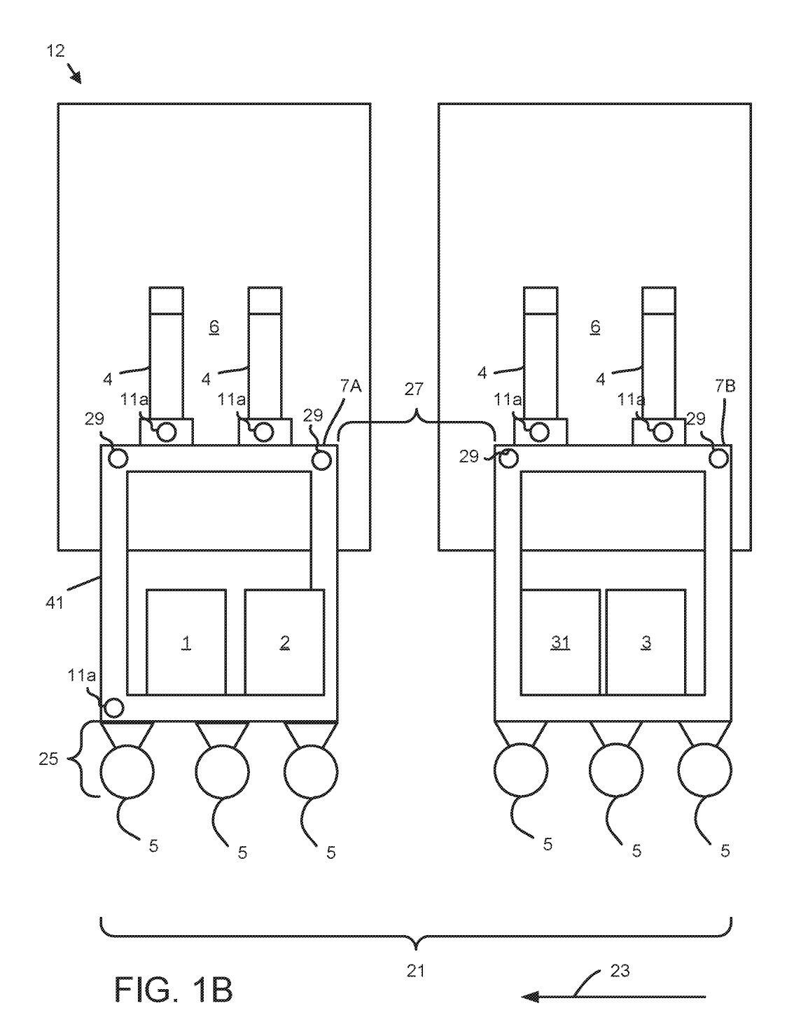

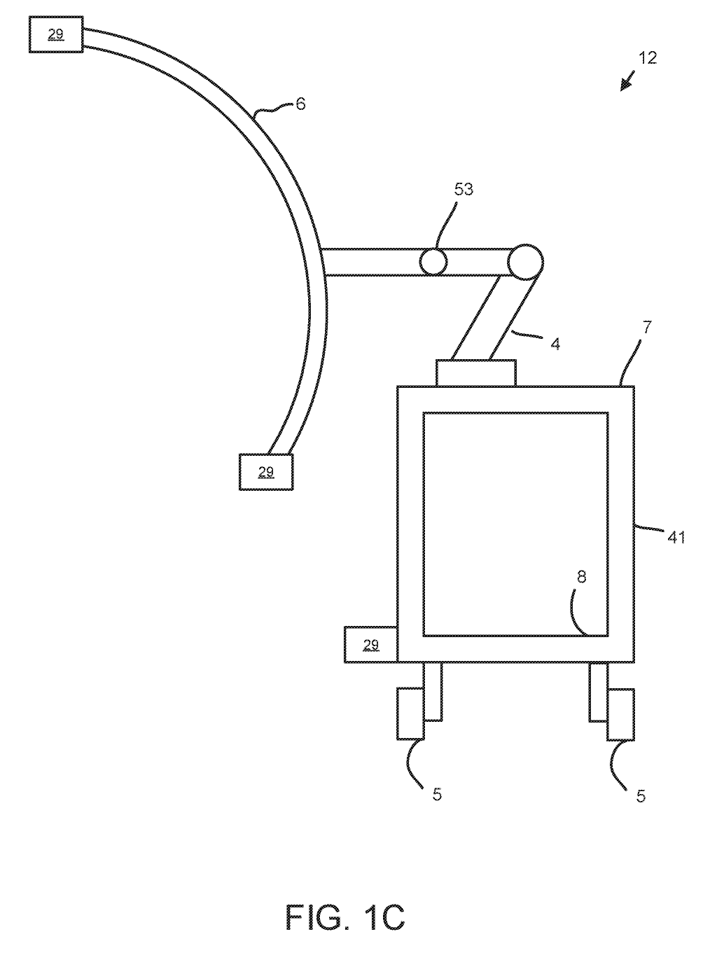

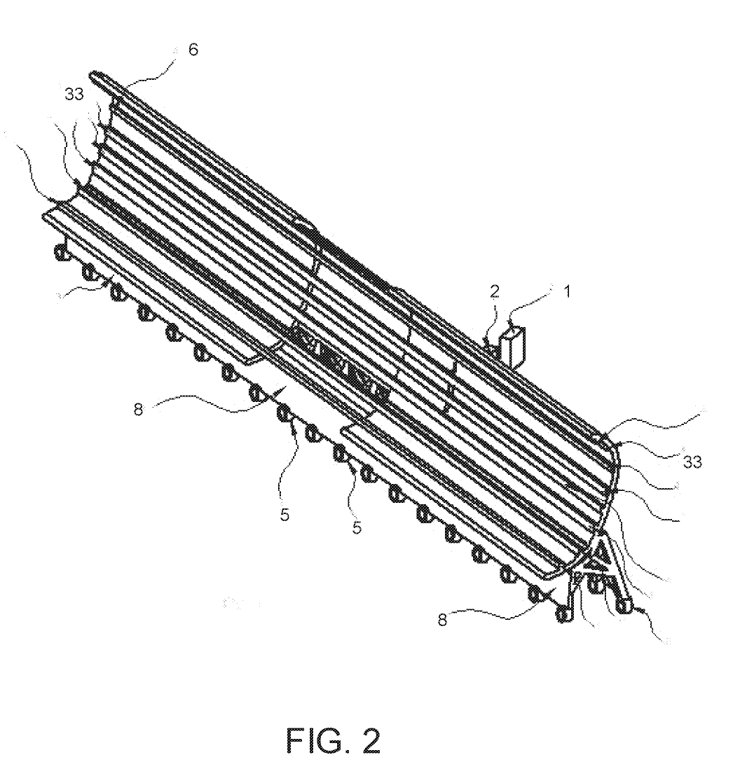

FIG. 1A is a perspective drawing illustrating one embodiment of a deicing system 12. The deicing system 12 may deice an aircraft in close proximity to a runway so that the aircraft may take off shortly after deicing is completed. Currently, aircraft are moved away from near the runway to a special deicing location or facility. The special deicing location is needed to collect and contain the toxic chemicals used in the deicing process.

Unfortunately, moving the aircraft to the deicing location adds significantly to travel delays. In addition, the aircraft must travel back to the runway after deicing, a delay that may result in additional icing. The embodiments described herein allow the aircraft to be deiced in close proximity to the runway, so that the aircraft may then take off immediately after deicing.

In the depicted embodiment, the deicing system 12 includes an operator control room 1, an engine/generator set 2, a heater/water holding tank 3, one or more robots, referred to hereinafter as articulated arms 4, one or more shells 6, one or more wheel assemblies 5, a deck 7, and a base 8. The base 8 may have a length 21 along a longitudinal axis 23 that is substantially equivalent to a length of a specified aircraft and that has a clearance 25 in the range of 1 to 3 meters. In one embodiment, the clearance is substantially equivalent to 2 meters. As used herein, substantially equivalent is within 25%.

A plurality of motorized wheel assemblies 5 may be disposed under the base 8. A movement direction of each wheel assembly 5 may be rotatable about a vertical axis. In one embodiment, the movement direction of each wheel assembly 5 is rotatable 360° about the vertical axis. The plurality of wheel assemblies 5 may move the deicing system 12 adjacent to the aircraft.

A deck 7 may be disposed above the base 8. In one embodiment the proximal deck 7A and a distal deck 7B are disposed above the base 8. In the depicted embodiment, the proximal deck 7A and the distal deck 7B may be separated by a wing gap 27 that admits a wing of the aircraft to pass between the proximal deck 7A and the distal deck 7B.

In one embodiment, the deicing system 12 includes a plurality of sensors 29 that measure distances between the base 8, the proximal deck 7A, the distal deck 7B, and the aircraft. In a certain embodiment, the deicing system 12 comprises a controller 31 that maneuvers the plurality of motorized wheels 5 in response to the sensor measurements. The controller 31 may use the sensor measurements to avoid collision with the aircraft.

The articulated arms 4 may position shells 6 near the airplane to deice the airplane. The articulated arms 4 may have one, two, and/or three degrees of freedom. Each articulated arm 4 may comprise a manual override 11b that halts motion of the articulated arm 4. The controller may retract the articulated arm 4 in response to activation of the manual override 11b. In addition, the system 12 may include a global manual override 11a. The articulated arms 4 may retract to a neutral position in response to activating the global manual override 11a.

FIG. 1B is a schematic side view drawing illustrating one embodiment of a deicing system 100. The deck 7 and the base 8 may form a crane unit 41. A crane unit 41 may be connected to another crane unit 41 by the base 8. Alternatively, crane units 41 may be separate.

FIG. 1C is a schematic front view drawing illustrating one embodiment of the deicing system 12. The articulated arm 4 is shown with the shell 6 retracted from the airplane. In the depicted embodiment, sensors 29 are disposed on the shell 6 and the crane unit 41. In one embodiment, the sensors 29 are proximity sensors. In addition, the sensors 29 may include a thermal sensor and/or a camera. The sensors 29 may determine a distance to the aircraft.

Each articulated arm 4 may comprise a failure sensor 53. The controller may retract the articulated arm 4 in response to the failure sensor 53 detecting a failure of the articulated arm 4.

FIG. 2 is a perspective drawing illustrating one embodiment of a fuselage shell 6. The shell 6 may be disposed on the end of an articulated arm 4. The articulated arm 4 may position the shell 6 in proximity to the aircraft. In one embodiment, the shell 6 is disposed about 3 feet from the aircraft. In one embodiment, the shell 6 is 2.5 to 3.5 feet from the aircraft. The depicted fuselage shell 6 is curved to conform with the shape of the aircraft fuselage.

In one embodiment, each shell 6 includes one or more heating elements 33. The heating elements 33 may be electric heating elements 33, steam heating elements 33, and/or hot water heating elements 33.

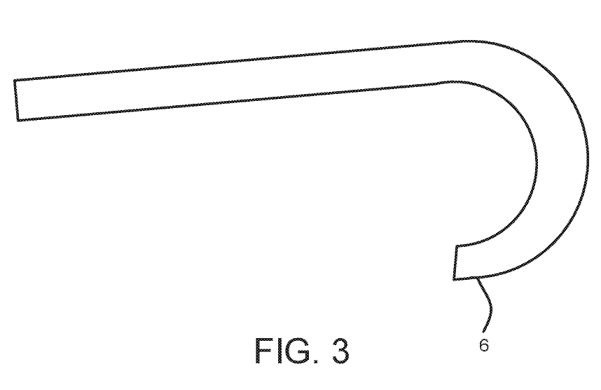

FIG. 3 is a side view drawing illustrating one embodiment of a wing and tail shell 6. The depicted shell 6 is shaped to conform to the surfaces of an aircraft wing and/or an aircraft tail.

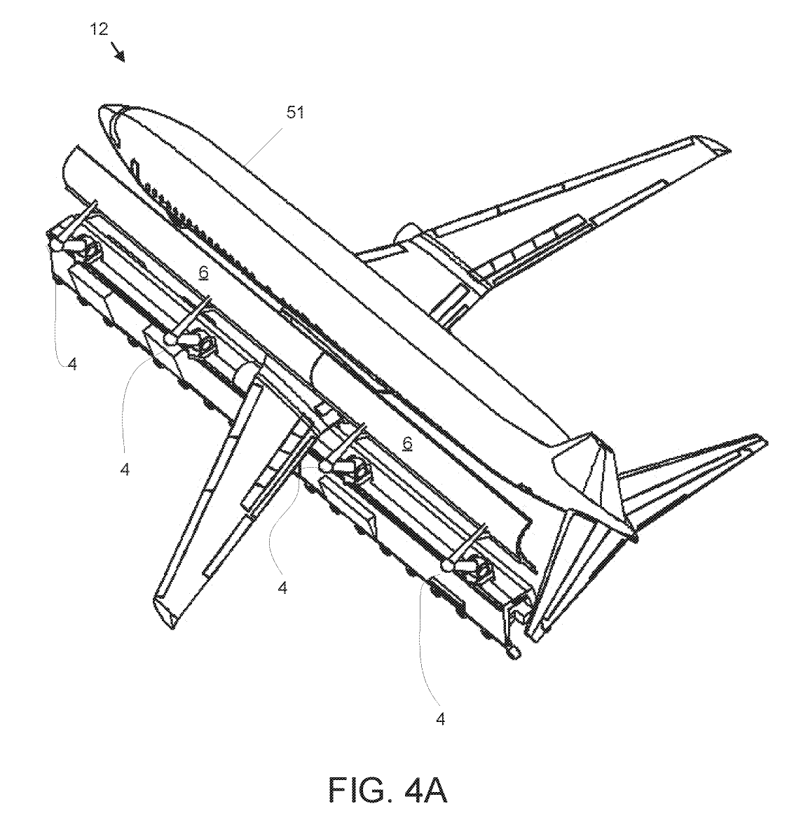

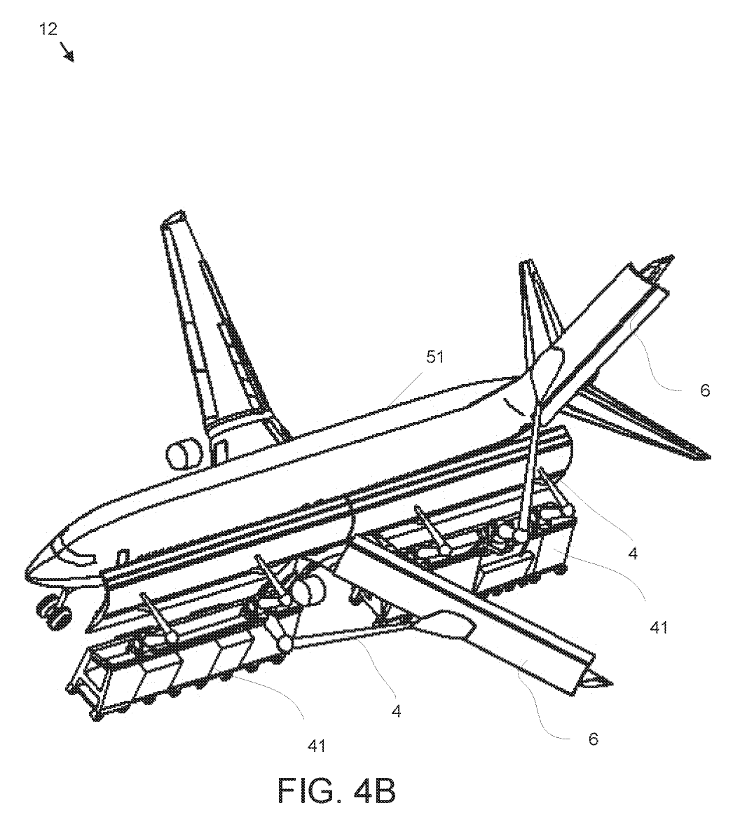

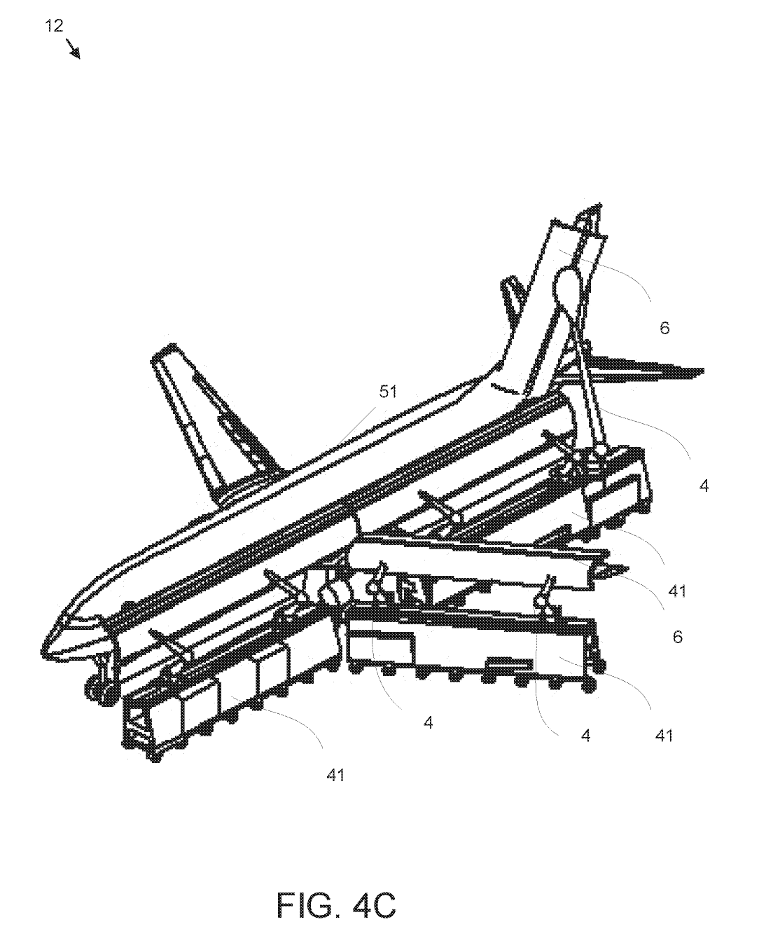

FIG. 4A is a perspective drawing illustrating one embodiment of a deicing system 12 adjacent to an aircraft 51. In the depicted embodiment, the shells 6 are disposed over the deck 7 and retracted from the airplane. The shells 6 may be disposed on the plurality of articulated arms 4 to abut each other and to cover the aircraft 51. The shells 6 form cover over the aircraft 51 so that the aircraft 51 may be deiced in any kind of weather at the end of the runway, allowing the aircraft 51 to take off immediately.

FIG. 4B is a perspective drawing illustrating one embodiment of the deicing system 12 adjacent to an aircraft 51 as in FIG. 4A. In the depicted embodiment, the shells 6 are disposed over the wing and tail of the airplane by the articulated arms 4.

In one embodiment, the shells 6 and/or other catchment devices are disposed to collect water from the aircraft 51. The water may be pumped to the heater/water holding tank 3. As a result, the aircraft 51 may be deiced close to the runway.

FIG. 4C is a perspective drawing illustrating one embodiment of a deicing system 12 adjacent to an aircraft 51. In the depicted embodiment, a third crane unit 41 supports the articulated arms 4 positioning the shell 6 over the wing.

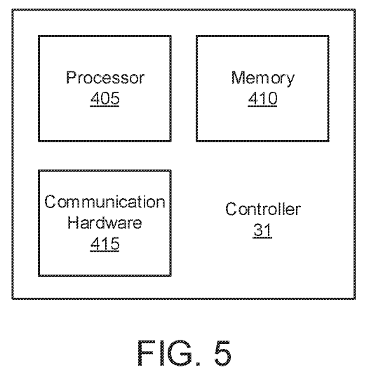

FIG. 5 is a schematic block diagram illustrating one embodiment of a controller 31. In the depicted embodiment, the controller 31 includes a processor 405, a memory 410, and communication hardware 415. The memory 410 may include a semiconductor storage device, a hard disk drive, an optical storage device, or combinations thereof. The memory 410 may store code. The processor 405 may execute the code. The communication hardware 415 may communicate with other devices such as a user interface, the wheel assemblies 5, the sensors 29, and/or the manual override 11.

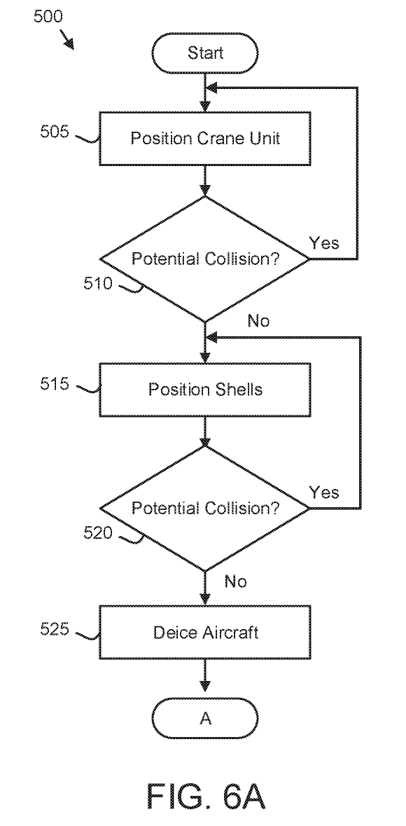

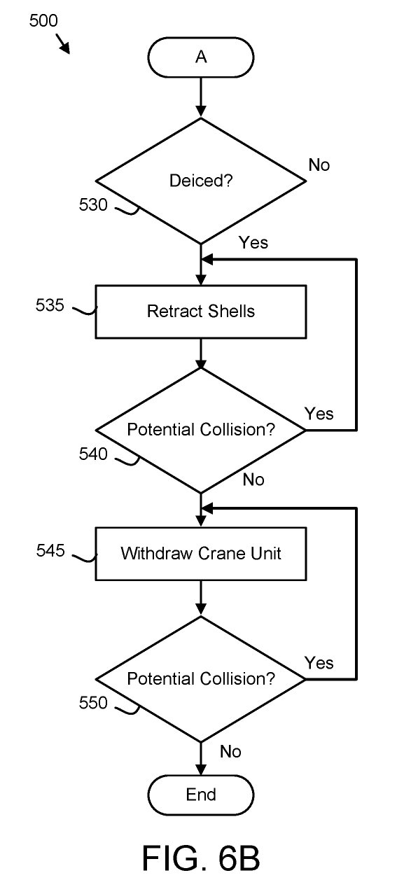

FIG. 6A-B are schematic flow chart diagrams illustrating one embodiment of an aircraft deicing method 500. The method 500 may be performed by the deicing system 12. In one embodiment, an operator directs the deicing system 12 and/or the controller 31.

The method 500 starts, and in one embodiment, the wheel assemblies 5 position 505 the crane unit 41 in proximity to the aircraft 51. The crane unit 41 may be positioned at an operation position 25 feet from the aircraft 51. In a certain embodiment, the operation position is in the range of 15 to 35 feet from the aircraft 51. The processor 405 may direct the wheel assemblies 5 to position 505 the crane unit 41. The sensors 29 may indicate to the processor 405 if the crane unit 41 is in the operation position.

The processor 405 may determine 510 if a sensor 29 detects a potential collision of the crane unit 41 with the aircraft 51 or other object. If a sensor 29 detects a potential collision, the processor 405 may direct the wheel assemblies 5 to reposition 505 the crane unit 41 to avoid the collision.

If no collision is detected and the crane unit 41 is positioned in the operation position, the articulated arms 4 may position 515 the shells 6 adjacent to the aircraft 51. The articulated arms 4 may be controlled by the processor 405. Each shell 6 may be disposed in a heating position that is 3 feet from a surface of the aircraft 51. In one embodiment, the heating position is in the range of 2.5 to 3.5 feet. The sensors 29 may indicate to the processor 405 if the shell 6 is in the heating position.

The processor 405 may determine 520 if a sensor 29 detects a potential collision of a shell 6 with the aircraft 51 or other object. If the sensor 29 detects a potential collection, the processor 405 may direct the articulated arms 4 to reposition 515 the shell 6 to avoid the collision.

If the shells 6 are in the heating position, the processor 405 may activate the heating elements 33 and deice 525 the aircraft 51. The processor 405 may adjust the shells 6 to prevent the surface temperature of the aircraft 51 from exceeding a specified temperature threshold, such as 120° F.

In one embodiment, the processor 405 and the sensors 29 determine 530 if the aircraft 51 is deiced. The aircraft 51 may be deiced if the sensors 29 detect that the surface of the aircraft 51 has reached a specified temperature. In addition, the aircraft 51 may be deiced if the sensors 29 detect that the surface of the aircraft 51 is free of ice.

In response to deicing the aircraft 51, the processor 405 may direct the articulated arms 4 to retract 550 the shells 6. The processor 405 may determine 540 using the sensors 29 if there is a potential collision with the aircraft 51 or another object. If there is a potential collision, the processor 405 may direct the articulated arms 4 to retract 535 the shells 6 so as to avoid the collision.

In response to retracting 535 the shells 6, the processor 405 may direct the wheel assemblies 4 to withdraw 545 the crane unit 41. The processor 405 may determine 550 using the sensors 29 if there is a potential collision with the aircraft 51 or other object. If there is a potential collision, the processor 405 may direct the wheel assemblies 5 to withdraw the 545 the crane unit 41 so as to avoid the collision. In response to withdrawing 545 the crane unit 41 without a collision, the method 500 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A deicing system comprising:
a base with a length along a longitudinal axis that is substantially equivalent to a specified aircraft;
a plurality of motorized wheel assemblies disposed under the base, wherein a movement direction of each wheel assembly is rotatable about a vertical axis;
a proximal deck and a distal deck disposed above the base and separated by a wing gap that admits a wing of the aircraft to pass between the proximal deck and the distal deck;
a plurality of articulated arms disposed on the proximal deck and the distal deck, wherein a shell is disposed on an end of each articulated arm and each shell comprises a heating element,
wherein the plurality of motorized wheel assemblies moves the deicing system adjacent to the aircraft and the plurality of articulated arms each position a shell in proximity to the aircraft.

2. The deicing system of claim 1, the deicing system further comprising a plurality of sensors that measure distances between the base, the proximal deck, and the distal deck and the aircraft.

3. The deicing system of claim 2, the deicing system further comprising a controller that maneuvers the plurality of motorized wheels in response to the sensor measurements.

4. The deicing system of claim 3, wherein each articulated arm comprises a failure sensor and the controller retracts an articulated arm in response to the failure sensor detecting a failure of the articulated arm.

5. The deicing system of claim 4, wherein each articulated arm further comprises a manual override and the controller retracts the articulated arm in response to activation of the manual override.

6. The deicing system of claim 2, wherein the plurality of sensors each comprise at least one of a proximity sensor, a thermal sensor, and a camera.

7. The deicing system of claim 1, each articulated arm further comprises a shell disposed over the heater elements.

8. The deicing system of claim 7, where the shells disposed on the plurality of articulated arms abut to cover the aircraft.

9. A deicing system comprising:
a base with a length along a longitudinal axis that is substantially equivalent to a specified aircraft;
a plurality of motorized wheel assemblies disposed under the base, wherein a movement direction of each wheel assembly is rotatable about a vertical axis;
a deck disposed above the base;
a plurality of articulated arms disposed on the deck, wherein a shell is disposed on an end of each articulated arm and each shell comprises a heating element,
wherein the plurality of motorized wheel assemblies moves the deicing system adjacent to the aircraft and the plurality of articulated arms each position a shell in proximity to the aircraft.

10. The deicing system of claim 9, the deicing system further comprising a plurality of sensors that measure distances between the base, the deck and the aircraft.

11. The deicing system of claim 10, the deicing system further comprising a controller that maneuvers the plurality of motorized wheels in response to the sensor measurements.

12. The deicing system of claim 11, wherein each articulated arm comprises a failure sensor and the controller retracts an articulated arm in response to the failure sensor detecting a failure of the articulated arm.

13. The deicing system of claim 12, wherein each articulated arm further comprises a manual override and the controller retracts the articulated arm in response to activation of the manual override.

14. The deicing system of claim 10, wherein the plurality of sensors each comprise at least one of a proximity sensor, a thermal sensor, and a camera.

15. The deicing system of claim 9, each articulated arm further comprises a shell disposed over the heater elements.

16. The deicing system of claim 15, where the shells disposed on the plurality of articulated arms abut to cover the aircraft.
